(19) United States
(12) Patent Application Publication
(10) Pub. No.: US 2013/0012222 A1
(43) Pub. Date: Jan. 10, 2013

(54) METHOD FOR PROCESSING USER EQUIPMENT CONNECTION UNDER A MIXED MODE AND FEMTOCELL SYSTEM

(75) Inventor: Ling Zhu, Su Zhou City (CN)

(73) Assignee: SERNET (SUZHOU) TECHNOLOGIES CORPORATION, JIANGSU (CN)

(21) Appl. No.: 13/540,750

(22) Filed: Jul. 3, 2012

(30) Foreign Application Priority Data
Jul. 4, 2011 (CN) 201110185404.9

(51) Int. Cl. H04W 72/10; H04W 52/24; H04W 24/00

(52) U.S. Cl. 455/452.1

(57) ABSTRACT

A method for processing user equipment (UE) connection under a mixed mode and a femtocell system are provided. The method for processing UE connection is used in a femtocell for processing the connection of a UE. The method includes the following steps. A connection request is received from a low priority UE under a mixed mode. Whether the measurement results corresponding to the femtocell satisfy threshold settings is determined in response to the connection request, wherein the measurement results include a path loss corresponding to the femtocell. If the measurement results satisfy the threshold settings, then the low priority UE is allowed to be connected to the femtocell. In one embodiment, suitable resource allocation, such as the allocation of power and code resource, is provided after the low priority UE is connected to the femtocell under the mixed mode.

This application claims the benefit of People's Republic of China application Serial No. 201110185404.9, filed Jul. 4, 2011, the subject matter of which is incorporated herein by reference.

### BACKGROUND OF THE INVENTION

1. Field of the Invention

The invention relates in general to a user equipment (UE) processing method and a femtocell system, and more particularly to a method for processing UE connection under a mixed mode and a femtocell system.

2. Description of the Related Art

In a mobile communication system (such as a 3G network), a femtocell links user equipments (UE) located within a household or a small zone via an air interface, and further links the UE to a network of an operator via a broadband network so as to achieve mobile data offloading. In this manner, indoor communication quality is improved, and voice and data services may be provided at a lower cost.

The femtocell, such as a home node-B (HNB) and a home evolved node-B (HeNB), provides wireless coverage for the UE located within a household. The femtocell provides a connection service to the UE. According to the 3GPP standard, the femtocell provides three connection modes, namely, the open mode, the mixed mode and the closed mode. Under the open mode, every UE is unconditionally allowed to connect to the femtocell. Under the mixed mode, some UEs can be connected to the femtocell with higher priority, and other UEs can be connected to the femtocell with lower priority. Under the closed mode, connection service is provided to specified UE(s) only.

The mixed mode is an important mode for the femtocell. However, the connection under the mixed mode is still lacking of agreed protocols, and details for implementing priority are not yet provided.

### SUMMARY OF THE INVENTION

The invention is directed to user equipment (UE) processing method under a mixed mode and a femtocell system.

According to one embodiment of the present invention, a method for processing UE connection under a mixed mode for use in a femtocell is provided. The method includes the following steps. A connection request is received from a low priority UE under a mixed mode. Whether the measurement results corresponding to the femtocell satisfy threshold settings is determined in response to the connection request, wherein the measurement results include a path loss corresponding to the femtocell. If the measurement results satisfy the threshold settings, then the low priority UE is allowed to be connected to the femtocell.

According to one embodiment of the present invention, a femtocell system for processing the connection of a UE is provided. The femtocell system includes a mobile communication unit and a processing unit. The processing unit is coupled to the mobile communication unit for controlling the mobile communication unit to operate under at least one mobile communication mode. Under the mixed mode, the processing unit receives a connection request from a low priority UE. The processing unit, in response to the connection request, determines whether the measurement results corresponding to the femtocell satisfy threshold settings, wherein the measurement results include a path loss corresponding to the femtocell. If the measurement results satisfy the threshold settings, then the processing unit controls the mobile communication unit to allow the low priority UE to be connected to the femtocell.

In one embodiment, suitable resource allocation, such as the allocation of power and code resource, is provided after the low priority UE is connected to the femtocell under the mixed mode.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 shows an embodiment of a method for processing UE connection.

FIG. 2A and FIG. 2B illustrate sequence diagrams of some embodiments in which the processing method of FIG. 1 is implemented between a UE and a femtocell by using RRC protocol.

FIG. 3 shows an embodiment of a femtocell system with a mixed mode.

### DETAILED DESCRIPTION

Detailed descriptions with appended drawings are disclosed below for elaborating the operations and structures in terms of exemplary embodiments.

Embodiments of a user equipment (UE) processing method under a mixed mode and a femtocell are disclosed below. In one embodiment, the femtocell processes a connection request sent by a low priority UE under a mixed mode. The quality of the signal is used as a criterion for determining whether to allow the connection of the low priority UE. Furthermore, after the low priority UE is connected to the femtocell, resource allocation under a mixed mode is performed. Furthermore, an embodiment of a femtocell with a mixed mode is provided.

Under the mixed mode, the femtocell needs to process the UE connection request of both high priority UE and low priority UE (or the low priority UE may be regarded as a non-prioritized UE). Under the mixed mode, the femtocell should prioritize the connection request of the high priority UE and accordingly allocate more resources to the high priority UE even when the signal quality is poor. The UE is conformed to the 3GPP standard, such as a UE for WCDMA or TD-SCDMA. Examples of the UE include communication devices such as a smart phone, a tablet PC, an e-book and so on.

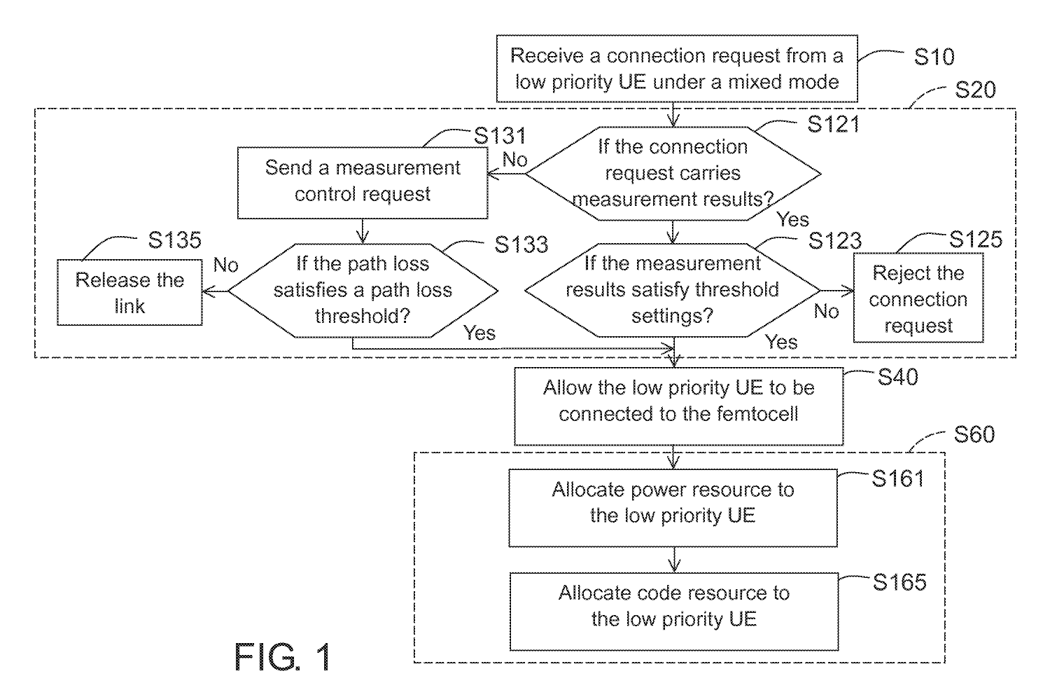

In response to the request of high priority UE, the femtocell needs o make suitable allocation for resource saving. According to one embodiment, when a low priority UE requests connection, the femtocell adopts signal quality as a criterion for determining whether to allow the connection request of the low priority UE, wherein the criterion of the signal quality also includes the amount of path loss. As illustrated in FIG. 1, an embodiment of a method for processing UE connection is shown. In step S10, a connection request from a low priority UE is received under a mixed mode. As shown in step S20, in response to the connection request, whether the measurement results corresponding to the femtocell satisfy the threshold settings is determined, wherein the measurement results include the path loss corresponding to the femtocell. In step S40, the low priority UE is allowed to connect to the femtocell if the measurement results satisfy the threshold settings.

The implementation of using the signal quality as a criterion for determining whether to allow the low priority UE to connect to the femtocell as shown in step 20 elaborates the subsequent processing of resource allocation and saving. In one embodiment, step S20 may include step S123 so as to determine whether the measurement results corresponding to the femtocell satisfy the threshold settings, wherein the connection request carries the measurement results corresponding to the femtocell. The measurement results for the femtocell may be indicated by using, for example, an information element (IE) of measured results on random access channel (RACH) of a radio resource control (RRC) connection request according to the 3GPP standard. According to the 3GPP standard, the IE of the measurement results carried by the RCC connection request includes an Ec/N0 value of a common pilot channel (CPICH) corresponding to a particular cell (e.g., the femtocell), a received signal code power (RSCP) value from the CPICH, and a path loss value. The above three values respectively are the dB value indicating signal quality, the dBm value indicating signal strength, and the dB value indicating path loss.

When the signal quality is good enough (that is, the measurement results corresponding to the femtocell satisfy the threshold settings; e.g., the Ec/N0 value, the RSCP value, and the path loss value satisfy respective thresholds), will the low priority UE be linked to the femtocell. For example, if the path loss value of the measurement results is less than a path loss threshold (such as less than 60 dB), then the low priority UE is allowed to connect to the femtocell, as shown in step S40. The threshold settings, such as the above three thresholds, may be set according to the resource allocation of the femtocell or the needs of the bearers allocated to the UE, or obtained from the core network. If the signal quality is not good enough (that is, the measurement results corresponding to the femtocell do not satisfy the threshold settings), then the femtocell does not allow the connection of the low priority UE. For example, if the path loss value is greater than a path loss threshold (such as greater than 60 dB), then the connection request of the low priority UE is rejected, as shown in step S125. Particularly, if the path loss does not satisfy a path loss threshold of the threshold settings, a message is sent to inform that the connection request of the low priority UE is rejected, as shown in step S125. That the path loss does not satisfy the path loss threshold has a physical meaning that the distance between the UE and the femtocell has been over a specific distance, and the femtocell will need to increase its output power if the connection request of the UE is allowed. Under such circumstance, the femtocell will reject the connection request of the low priority UE so as to avoid wasting more resources. In other words, such approach reserves the resources for the high priority UE.

In one embodiment, step S20 may be implemented to include such as step S121, so as to determine whether the connection request carries measurement results corresponding to the femtocell. If not, as shown in step S131, a measurement control request is sent to the low priority UE so as to obtain the path loss corresponding to the femtocell. In step S133, whether the path loss satisfies a path loss threshold of the threshold settings is determined. If not, then the process proceeds to step S135 so as to release the link.

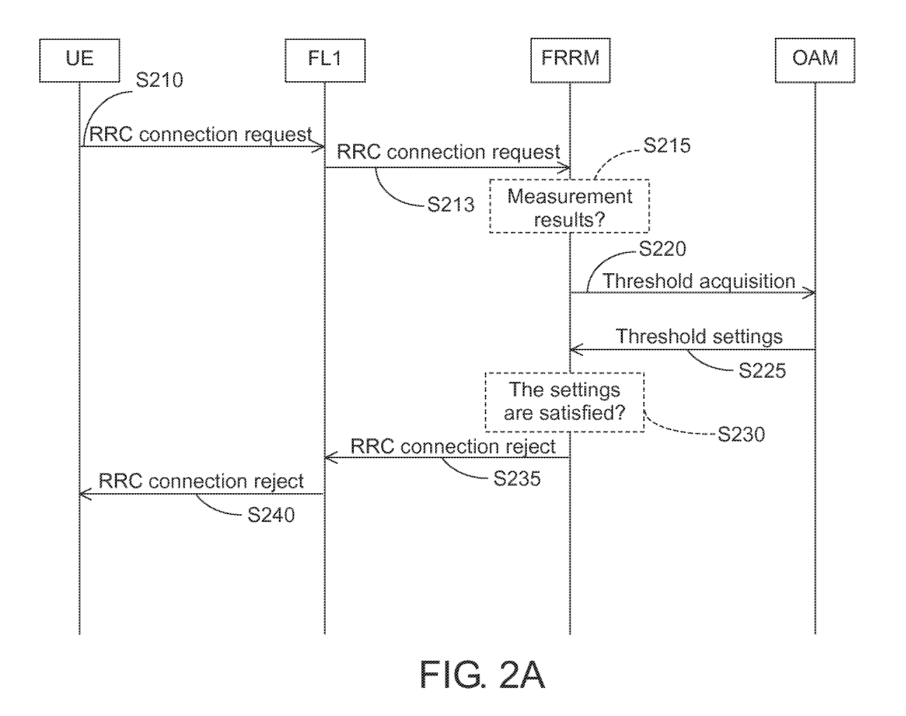

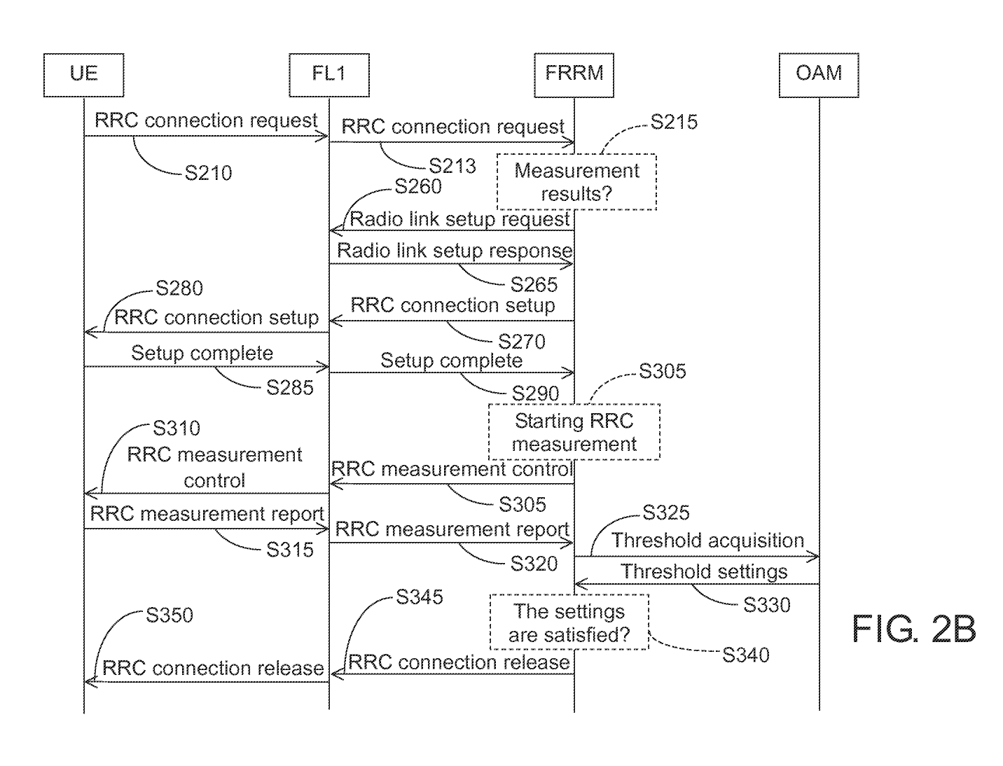

The method for processing the connection request of low priority UE as shown in FIG. 1 may be implemented between the UE and the femtocell according to the RRC protocol. For example, as shown in FIGS. 2A and 2B, the sequence diagrams illustrate the interaction between the UE and the femtocell.

As shown in FIGS. 2A and 2B, the femtocell layer 1 (FL1) unit denotes a logic unit or hardware unit for interconnections between the femtocell and the UE, for example, by using layer 1 Uu air interface of 3G mobile communication. The femtocell radio resource management (FRRM) unit denotes a logic unit or hardware unit for performing the operation related to radio resource management (RRM) between the FL1 unit and the core network OAM (such as the network of the operator). In one embodiment, the FL1 unit and the FRRM unit can be combined as a physical device of the femtocell. In another embodiment, the FRRM unit can be implemented as a dedicated device.

Referring to FIG. 2A, step S210 indicates that the user equipment UE sends an RRC connection request carrying measurement results corresponding to the femtocell. As shown in step S213, the FL1 unit receives and further transmits the connection request to the FRRM unit. As shown in step S215, the FRRM unit determines whether the RRC connection request carries measurement results (like the step S121 of FIG. 1). As shown in step S220, the FRRM unit sends a threshold capture message to the core network OAM. As shown in step S225, the core network OAM sends a signal strength threshold. As shown in step S230, the FRRM unit determines whether the measurement results satisfy the threshold settings. If not, as shown in step S235, the FRRM unit sends an RRC reject message through a common control channel (CCCH). As shown in step S240, the RRC reject message is transmitted to the user equipment UE through the FL1 unit.

Referring to FIG. 2B, in step S210, the user equipment UE sends an RRC connection request without carrying measurement results corresponding to the femtocell. As shown in step S213, the FL1 unit receives and further transmits the request to the FRRM unit. As shown in step S215, FRRM unit determines that the RRC connection request does not carry measurement results. As shown in steps S260 to S290, an RRC link is first set up between the femtocell and the FRRM unit, according to the RCC protocol. Then, the process proceeds to step S305. In step S305, an RRC measurement control message is sent to obtain the measurement results for further determination. As to step S260, the FRRM unit sends a radio link setup request (such as an NBAP RL setup request) to the FL1 unit to request the FL1 unit (that is, Node B) to allocate particular RRC resources. In step S265, the FL1 unit, in response to the message, sends a radio link setup response (such as an NBAP RL setup response) to the FRRM. Then, the process proceeds to step S270, the FRRM unit sends an RRC connection setup message to the FL1 unit. In step S280, the FL1 unit transmits the RRC connection setup message to the user equipment UE. In step S285, the user equipment UE sends an RRC connection setup complete message to the FL1 unit. Then, step S290 indicates that the FL1 unit sends the RRC connection setup complete message to the FRRM unit.

Since the above RRC connection request does not carry measurement results, the FRRM unit sends an RRC measurement control request to the FL1 unit, as in step S305. In step S310, the FL1 unit sends the RRC measurement control message to the user equipment UE. In step S315, the user equipment UE sends an RRC measurement report to the FL1 unit. In step S320, the FL1 unit transmits the RRC measurement report to the FRRM unit. As shown in step S325, the FRRM unit sends a threshold acquisition message to the core network OAM. As shown in step S330, the core network OAM sends threshold settings message to the FRRM. As shown in step S340, the FRRM unit determines whether the measurement results corresponding to the femtocell satisfy the threshold settings. If the path loss in the measurement results does not satisfy a path loss threshold, then a message is sent to inform the low priority UE that the connection request is rejected. As shown in step S345, the FRRM unit sends an RRC connection release message through a dedicated control channel (DCCH). As shown in step S350, the RRC connection release message is transmitted to the user equipment UE through the FL1 unit. In other words, the RRC connection request is rejected.

The RRC protocol is taken as an example of protocol for used in the above embodiments. However, the RRC protocol, as it is established, has nothing to do with the method for processing the connection request of low priority UE under a mixed mode, and the protocols for processing connection as shown in FIG. 1 are not limited to the RRC protocol.

Referring again to FIG. 1, after the low priority UE is connected to the femtocell, the method may further include such as step S60 for allocating resources corresponding to bearers. As illustrated in FIG. 1, step S60 may include step S161 and step S165. In step S161, power resource is allocated to low priority UE. In step S165, code resource is allocated to low priority UE. In implementation, the sequence of step S161 and step S165 is free of restriction.

Various embodiments regarding the allocation of power resource are discussed below. The allocation of power resource has two scenarios, namely the uplink transmission and the downlink transmission.

In terms of downlink transmission, the transmission power of the femtocell is to be controlled so that the burden is alleviated and more resources may be reserved to the high priority UE. Consequently, the transmission power of the entire radio link tends to be set conservatively. In one embodiment, step S161 may include the following steps. The upper limit of the transmission power of the femtocell is controlled to be substantially a maximum downlink power MAX_DL_Power, wherein the maximum downlink power MAX_DL_Power is determined according to the maximum allowed path loss MAX_Pathloss, and the maximum allowed path loss MAX_Pathloss may have different values for low priority UE and for high priority UE. Thus, the maximum allowed path loss for low priority UE is designated as MAX_Pathloss_Low_UE, and the maximum allowed path loss for high priority UE is designated as MAX_Pathloss_High_UE. In one embodiment, the maximum downlink power MAX_DL_Power is determined according to the MAX_Pathloss, the received total wideband power offset RTWP_offset, and the UE optimized uplink reception level UE_optimized_UL_RX_Level. For example, the maximum downlink power MAX_DL_Power can be expressed as:

MAX_{—}DL_Power=MAX_Pathloss+RTWP_offset+UE_optimized_{—}UL_{—}RX_Level. (formula 1)

Since the values of the maximum allowed path loss may be different for low priority UE and high priority UE, the corresponding values of maximum downlink power MAX_DL_Power need to be set separately.

In the above example, the maximum downlink power MAX_DL_Power is determined based on the maximum allowed path loss MAX_Pathloss while the MAX_Pathloss_Low_UE or the MAX_Pathloss_High_UE may be assigned or adjusted. Therefore, the values of the MAX_DL_Power corresponding to the UE with different priority levels can be obtained by adjusting the value of the MAX_Pathloss_Low_UE or MAX_Pathloss_High_UE so as to avoid wasting power resource of the femtocell. In another example, when the user equipment UE is near the femtocell, the value of the MAX_Pathloss_Low_UE or MAX_Pathloss_High_UE may be adjusted for the femtocell to reduce output power. Thus, in some embodiments, by assigning or adjusting the volume of the MAX_Pathloss, the user equipment UE may allocate power resource of the femtocell more flexibly and effectively. As an example, for system operation or femtocell installation, the operator may set the quantity of the MAX_Pathloss_Low_UE or MAX_Pathloss_High_UE with respect to the radio coverage zone of the femtocell. For example, the MAX_Pathloss_Low_UE is set to 70 dB, and the MAX_Pathloss_High_UE is set to 95 dB.

In terms of uplink transmission, since the interference problem needs to be considered, the maximum allowed uplink transmission power MAX_UL_TX_Power for low priority UE is set so that its interference to other UE is minimized. In one embodiment, step S161 may further include the following steps. A message is sent to inform the low priority UE to set the maximum allowed uplink transmission power for low priority UE, wherein the maximum allowed uplink transmission power MAX_UL_TX_Power is determined according to the maximum allowed path loss for low priority UE MAX_Pathloss_Low_UE. In one embodiment, the maximum allowed uplink transmission power MAX_UL_TX_Power is determined according to MAX_Pathloss_Low_UE, the RTWP_offset, and the femtocell optimized uplink reception level Femtocell_optimized_UL_RX_Level. For example, the maximum uplink power MAX_UL_TX_Power for low priority UE can be expressed as:

MAX_{—}UL_{—}TX_Power=MAX_Pathloss_Low_{—}UE+RTWP_offset+Femtocell_optimized_{—}UL_{—}RX_Level (formula 2)

In the above example, the maximum uplink power MAX_UL_TX_Power is determined according to the maximum allowed path loss for low priority UE MAX_Pathloss_Low_UE. Like the above example, the maximum uplink power MAX_UL_TX_Power for high priority UE is determined according to the maximum allowed path loss for high priority UE MAX_Pathloss_High_UE. The MAX_Pathloss_Low_UE or the MAX_Pathloss_High_UE may be assigned or adjusted. Therefore, the value of the MAX_UL_TX_Power corresponding to the UE with different priority level can be obtained by adjusting the value of the MAX_Pathloss_Low_UE or MAX_Pathloss_High_UE so as to avoid wasting power resource of the user equipment UE. In another example, when the user equipment UE is near the femtocell, the value of the MAX_Pathloss_Low_UE or MAX_Pathloss_High_UE may be adjusted for the user equipment UE to reduce output power. In the above embodiment, by assigning or adjusting the value of the MAX_Pathloss, the user equipment UE can allocate power resource more flexibly and effectively.

With respect to demodulation performance, the femtocell and the user equipment UE are different. The femtocell has better demodulation performance, and is able to demodulate the signal having lower quality. When transmitting a signal to the user equipment UE, the femtocell needs to transmit the signal with higher power in order for the user equipment UE to demodulate the signal received from the femtocell. Regarding the downlink power allocation as indicated in the embodiment of formula 1, the item UE_optimized_UL_RX_Level indicates that the demodulation performance of the user equipment UE needs to be concerned. Regarding the uplink power allocation as indicated in the embodiment of formula 2, the item Femtocell_optimized_UL_RX_Level indicates that the demodulation performance of the femtocell needs to be concerned. Since the user equipment UE (that is, an electronic device such as a smart phone, a tablet PC and so on) linked to the femtocell already satisfies the path loss threshold, in the above embodiment of power resource allocation, the allocation of the uplink power and downlink power is determined according to the maximum allowed path loss for low priority UE MAX_Pathloss_Low_UE. Thus, unnecessary power loss is avoided, the user equipment UE can make good use of its limited power, and battery duration is prolonged. For high priority UE, unnecessary power loss can also be avoided in the above embodiment of power resource allocation.

Various embodiments of code resource allocation are disclosed below. The allocation of code resource has two scenarios, namely, the uplink transmission and the downlink transmission. In the mixed mode, in order to reserve more resources for high priority UE, the allocation of code resource for low priority UE is restrictive, and packet service (PS) with lower speed bearers can be assigned.

For example, for low priority UE, the highest data rate for the uplink bearer is 64 Kbps. As shown in FIG. 1, after a low priority UE is connected to the femtocell, in one embodiment, step S165 may further include the following step. The femtocell, according to the version of the mobile communication technology supported by the low priority UE, is controlled to allocate an uplink bearer and a downlink bearer to the low priority UE with respect to the packet service. For example, when the version of the mobile communication technology supported by the low priority UE is R4 (Release 4) of 3G, the 64 Kbps uplink and downlink packet services PS are allocated to the UE. For example, when the version supported by the low priority UE in high speed downlink package access (HSDPA) is R5 or R6 of 3G, the 64 Kbps uplink packet service and the HSDPA packet service are allocated to the UE.

The femtocell prioritizes the UE with higher priority. After a high priority UE is connected to the femtocell, the processing unit allocates a bearer having larger bandwidth to the high priority UE. For example, if the high priority UE supports R4, uplink and downlink packet services with larger bandwidths, such as 128 Kbps uplink packet service and 384 Kbps downlink packet service, may be allocated to the high priority UE. If the high priority UE supports R5, the 128 Kbps uplink packet service and the HSDPA downlink packet service may be allocated to the high priority UE.

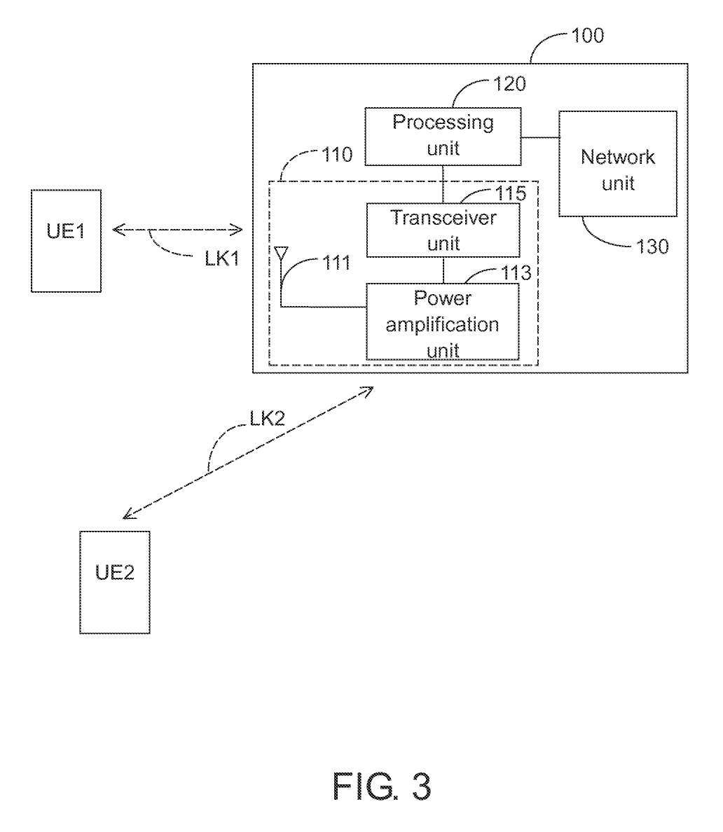

FIG. 3 shows an embodiment of a femtocell system having a mixed mode. In one embodiment, the femtocell system 100 includes a mobile communication unit 110 and a processing unit 120. The femtocell system 100 has a mixed mode. For example, the femtocell system 100 sets up a radio link LK1 for linking a high priority UE1, and sets up a radio link LK2 for linking a low priority UE2. The radio links LK1 and LK2 correspond to the bearers allocated by the femtocell system 100 according to the priority levels of the user equipment UE1 and UE2. Thus, the femtocell system 100 of FIG. 3 may be regarded as an implementation for processing the connection requests with respect to different priority levels under the mixed mode.

The mobile communication unit 110 may be regarded as an analog front end for wireless signal transmitting and receiving, and includes, for example, an antenna 111, a power amplification unit 113, and a transceiver unit 115. The antenna 111 is coupled to the power amplification unit 113, and the transceiver unit 115 is coupled to the power amplification unit 113. In other embodiments, the mobile communication unit 110 may be implemented with different elements or structure to correspond with at least one mobile communication mode (such as 2G, 3G or 4G) to be adopted. Thus, the elements of the mobile communication unit 110 are not limited to the examples above. For example, a 3G femtocell H(e)NB, such as a home node-B (HNB) and a home evolved node-B (HeNB), is capable of monitoring the universal mobile telecommunications system (UMTS) channel for detecting a base station nearby and a 2G channel. Thus, when the user equipment UE leaves the femtocell zone, the user equipment UE may perform suitable network switching. Thus, in the present example, the mobile communication unit 110 includes an analog front end corresponding to the UMTS channel and the 2G channel.

The processing unit 120 is coupled to the mobile communication unit 110 for controlling the mobile communication unit 110 to operate under at least one mobile communication mode (such as 2G, 3G or 4G mode). Under the mixed mode, the processing unit 120 receives a connection request from a low priority UE. In response to the connection request, the processing unit 120 determines whether the measurement results corresponding to the femtocell satisfy the threshold settings. The measurement results include the path loss corresponding to the femtocell. If the measurement results satisfy the threshold settings, then the processing unit 120 controls the mobile communication unit 110 to allow the low priority UE to be connected to the femtocell.

In one embodiment, after the low priority UE is connected to the femtocell, the processing unit controls the upper limit of the transmission power of the mobile communication unit to be substantially a maximum downlink power. In one embodiment, after the low priority UE is connected to the femtocell, the processing unit controls the mobile communication unit to send a message to inform the low priority UE to set the maximum allowed uplink transmission power for low priority UE.

In one alternate embodiment, after the low priority UE is connected to the femtocell, the processing unit, according to the version of the mobile communication technology supported by the low priority UE, controls the mobile communication unit to provide an uplink bearer and a downlink bearer to the low priority UE with respect to the packet service.

In other embodiments, the femtocell prioritizes UEs with higher priority. After a high priority UE is connected to the femtocell, the processing unit of the femtocell allocates bearers having larger bandwidth to the high priority UE.

Thus, the femtocell system 100 may be used for implementing the method for processing UE connection under the mixed mode, as disclosed in above embodiments, by using software, hardware, or firmware.

For example, the processing unit 120 can be realized by such as a micro-control unit (MCU), a field-programmable gate array (FPGA), an application specific integrated circuit (ASIC) or a system on chip (SoC).

As indicated in FIGS. 2A or 2B, the processing unit 120 may implement the FL1 unit and the FRRM unit as a physical entity of the femtocell, which may be regarded as a femtocell base station system. In one alternate embodiment, the FRRM unit may be implemented as a dedicated device realized by such as the processing unit of a femtocell gateway, and the FL1 unit may be realized by the processing unit of a femtocell base station. Thus, the FL1 unit and the FRRM unit may also be regarded as a femtocell base station system.

In one embodiment, the femtocell system 100 needs a broadband network for linking the UE to a network of an operator. Therefore the femtocell system 100 further includes a network unit 130 providing an interface between the femtocell system 100 and a broadband website. In one alternate embodiment, the network unit 130 provides an interface between the femtocell system 100 and a femtocell gateway. Thus, the elements of the femtocell system 100 may be added or omitted to fit the design needs, and the structure of the femtocell system 100 is not limited to the above exemplification.

In other embodiments, the 3G protocols, such as WCDMA or TD-SCDMA, or even the 4G mobile communication standards may be implemented according to the above embodiments to meet actual requirements.

The disclosure provides many embodiments of a method for processing UE connection under a mixed mode and a femtocell. In one embodiment, the femtocell processes a connection request of a low priority UE under a mixed mode for allowing the low priority UE, whose signal quality conforms to the threshold, to be connected to the femtocell, such that resources may be allocated more effectively. Furthermore, in some embodiments, power resource or code resource is effectively allocated after the low priority UE is connected to the femtocell. In addition, a number of embodiments of the femtocell under a mixed mode are disclosed and different methods for processing the UE having different priority levels under a mixed mode are provided.

While the invention has been described by way of example and in terms of the embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method for processing user equipment (UE) connection under a mixed mode, for use in a femtocell, the method comprising:
receiving a connection request from a low priority UE under a mixed mode;
determining, in response to the connection request, whether measurement results corresponding to the femtocell satisfy threshold settings, wherein the measurement results include a path loss corresponding to the femtocell; and
allowing the low priority UE to be connected to the femtocell if the measurement results satisfy the threshold settings.

2. The method for processing UE connection under a mixed mode according to claim 1, further comprising:
sending a message to inform the low priority UE that the connection request is rejected if the measurement results do not satisfy the threshold settings.

3. The method for processing UE connection under a mixed mode according to claim 2, wherein the connection request carries the measurement results corresponding to the femtocell.

4. The method for processing UE connection under a mixed mode according to claim 1, further comprising:
sending a message to inform the low priority UE that the connection request is rejected if the path loss does not satisfy a path loss threshold of the threshold settings.

5. The method for processing UE connection under a mixed mode according to claim 4, wherein when the connection request does not carry the measurement results corresponding to the femtocell, a measurement control request is sent, and the path loss corresponding to the femtocell is obtained from the low priority UE.

6. The method for processing UE connection under a mixed mode according to claim 1, further comprising:
after the low priority UE is connected to the femtocell, controlling an upper limit of transmission power for the femtocell to be substantially a maximum downlink power determined based on a maximum allowed path loss for low priority UE.

7. The method for processing UE connection under a mixed mode according to claim 6, wherein the maximum downlink power is determined according to the maximum allowed path loss for low priority UE, a received total wideband power offset, and a UE optimized uplink reception level.

8. The method for processing UE connection under a mixed mode according to claim 1, further comprising:
after the low priority UE is connected to the femtocell, sending a message to inform the low priority UE to set a maximum allowed uplink transmission power for the low priority UE, wherein the maximum allowed uplink transmission power is determined based on a maximum allowed path loss for low priority UE.

9. The method for processing UE connection under a mixed mode according to claim 8, wherein the maximum allowed uplink transmission power is determined based on the maximum allowed path loss for low priority UE, a received total wideband power offset, and a femtocell optimized uplink reception level.

10. The method for processing UE connection under a mixed mode according to claim 1, further comprising:
controlling the femtocell to allocate an uplink bearer and a downlink bearer to the low priority UE according to a version of the mobile communication technology supported by the low priority UE with respect to packet service after the low priority UE is connected to the femtocell.

11. A femtocell system for processing user equipment connection, comprising:
a mobile communication unit; and
a processing unit, coupled to the mobile communication unit for controlling the mobile communication unit to operate under at least one mobile communication mode, wherein under the mixed mode, the processing unit receives a connection request from a low priority UE; the processing unit, in response to the connection request, determines whether measurement results corresponding to the femtocell satisfy the threshold settings, wherein the measurement results include a path loss corresponding to the femtocell; and if the measurement results satisfy the threshold settings, then the processing unit controls the mobile communication unit to allow the low priority UE to be connected to the femtocell.

12. The femtocell system according to claim 11, wherein
if the measurement results do not satisfy the threshold settings, then the processing unit controls the mobile communication unit to send a message to inform the low priority UE that the connection request is rejected.

13. The femtocell system according to claim 12, wherein the connection request carries the measurement results corresponding to the femtocell.

14. The femtocell system according to claim 11, wherein
if the path loss does not satisfy a path loss threshold of the threshold settings, then the processing unit controls the mobile communication unit to send a message to inform the low priority UE that the connection request is rejected.

15. The femtocell system according to claim 14, wherein when the connection request does not carry the measurement results corresponding to the femtocell, the processing unit controls the mobile communication unit to send a measurement control request and obtain the path loss corresponding to the femtocell from the low priority UE.

16. The femtocell system according to claim 11, wherein
after the low priority UE is connected to the femtocell, the processing unit controls an upper limit of the transmission power of the mobile communication unit to be substantially a maximum downlink power determined according to a maximum allowed path loss for low priority UE.

17. The femtocell system according to claim 16, wherein the maximum downlink power is determined according to the maximum allowed path loss for low priority UE, a received total wideband power offset, and a UE optimized uplink reception level.

18. The femtocell system according to claim 11, wherein
after the low priority UE is connected to the femtocell, the processing unit controls the mobile communication unit to send a message to inform the low priority UE to set a maximum allowed uplink transmission power for low priority UE, wherein the maximum allowed uplink transmission power is determined according to a maximum allowed path loss for low priority UE.

19. The femtocell system according to claim 18, wherein the maximum allowed uplink transmission power is determined according to the maximum allowed path loss for low priority UE, a received total wideband power offset, and a femtocell optimized uplink reception level.

20. The femtocell system according to claim 11, wherein
the processing unit, according to a version of the mobile communication technology supported by the low priority UE, controls the mobile communication unit to provide an uplink bearer and a downlink bearer, with respect to packet service, to the low priority UE after the low priority UE is connected to the femtocell.
